(19) United States
(12) Patent Application Publication
(10) Pub. No.: US 2006/0251114 A1
(43) Pub. Date: Nov. 9, 2006

(54) Approach for collecting and reporting status data from network devices

(76) Inventors: Jayasimha Nuggehalli, Union City, CA (US); Attaullah Mirza-Baig, San Jose, CA (US)

Correspondence Address: HICKMAN PALERMO TRUONG & BECKER, LLP, 2055 GATEWAY PLACE, SUITE 550, SAN JOSE, CA, 95110, US

(21) Appl. No.: 10/810,118

(22) Filed: Mar. 25, 2004

(51) Int. Cl. H04J 3/16

(52) U.S. Cl. 370/466

(57) ABSTRACT

An approach is provided for collecting and reporting network device status data. The status data may be collected directly from network devices or via an intermediate device, such as a status data server, that collects the status data from network devices. The approach may include aggregating status data from several network devices so that the report data reflects status data from several network devices. The approach also includes formatting and translating data between one or more formats supported by the network devices, from which the status data was collected, and one or more formats supported by recipient devices to which the status data is reported. Status data and/or report data may be stored and report data provided to recipient devices based upon a specified time schedule.

### FIELD OF THE INVENTION

The present invention relates to network devices. The invention more specifically relates to collecting and reporting status data from network devices.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Some types of network devices are configured to provide status information. For example, some network devices are configured to provide information about firmware versions or communications protocols supported by the network devices. Other network devices, such as multifunction peripherals (MFPs) are configured to provide status information relating to consumables, such as paper, toner and staple levels, service calls and meter readings. As used herein, the term “MFP” refers to a single device that performs several functions. Example functions include, without limitation, printing, scanning, faxing and copying.

Status data is typically reported to different recipient devices, such as manufacturer servers and various vendor servers, to be used in a variety of ways. For example, a manufacturer or vendor may use network device status data to identify network devices that need to have a firmware update. As another example, a manufacturer or vendor may use status data from MFPs to provide billing services, to arrange for re-supplying of consumables or to arrange for service calls.

One issue with collecting and reporting status data from network devices is how status data is reported to different types of recipient devices that support different data formats and/or communications protocols. It is not uncommon for a vendor enterprise resource planning (ERP) site to implement a proprietary data format or communications protocol. For example, suppose that a first vendor server supports a first data format while a second vendor server supports a second data format that is different than the first data format. A network device that reports status data directly to both the first and second vendor servers must be configured to support both the first and second data formats. Configuring each network device to support multiple data formats and communications protocols is impractical, particularly for large deployments. Furthermore, data formats and communications protocols supported by recipient devices may change over time. For example, suppose that a particular vendor decides to implement a new data format on its vendor server. All network devices that provide report data to the particular vendor's server must be updated to provide report data in the new data format. Thus, even a single change in the data format or communications protocol of a recipient device may require updating a large number of network devices. The large number of data formats and communications protocols supported by recipient devices makes this approach impractical for large deployments.

Sometimes intermediary devices are used to collect status data from multiple network devices and then report the status data to recipient devices. For example, in large corporate deployments, it is not uncommon for status data servers to be used to collect status data from sets of network devices and then report the status data to recipient devices. Using status data servers to collect and report status data reduces the number of devices that must be configured to support the data formats and communications protocols of recipient devices, but does not adequately address the problem since many status data servers may still be required in large deployments.

In view of the forgoing, there is a need for an approach for collecting and reporting network device status data that does not suffer from limitations of the prior approaches.

### SUMMARY

An approach is provided for collecting and reporting network device status data. The approach may include aggregating status data from several network devices so that the report data reflects status data from several network devices. The approach also includes formatting and translating data between one or more formats supported by the network devices, from which the status data was collected, and one or more formats supported by recipient devices to which the status data is reported. Status data and/or report data may be stored and report data provided to recipient devices based upon a specified time schedule.

According to one aspect of the invention, an apparatus comprises a conversion mechanism configured to process network device status data that conforms to a first format and is received by the apparatus. The conversion mechanism is also configured to generate, based upon the status data, report data that conforms to a plurality of formats supported by a plurality of recipient devices.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A is a block diagram that depicts a network architecture for collecting and reporting network device status data in accordance with an embodiment of the invention.

FIG. 1B is a block diagram that depicts an architecture where a gateway receives status data from a status data server.

FIG. 2A is a block diagram that depicts a network architecture for collecting and reporting network device status data in accordance with another embodiment of the invention.

FIG. 2B is a block diagram that depicts an example embodiment of a gateway.

FIG. 3 is a flow diagram that depicts an approach for collecting and reporting network device status data according to an embodiment of the invention.

FIG. 4 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. ARCHITECTURE

III. FUNCTIONAL OVERVIEW

IV. FORMATTING AND SECURITY

V. OPERATIONAL EXAMPLE

VI. IMPLEMENTATION MECHANISMS

I. Overview

An approach is provided for collecting and reporting network device status data. The status data may be collected directly from network devices or via an intermediate device, such as a status data server, that collects the status data from network devices. The approach may include aggregating status data from several network devices so that the report data reflects status data from several network devices. The approach also includes formatting and translating data between one or more formats supported by the network devices, from which the status data was collected, and one or more formats supported by recipient devices to which the status data is reported. Status data and/or report data may be stored and report data provided to recipient devices based upon a specified time schedule. The approach is applicable to any type of status data, which may vary depending upon the particular network devices involved. Examples of status data include, without limitation, firmware versions, communications protocols supported by a network device, consumables, such as paper, toner and staple levels, service calls and meter readings.

II. Architecture

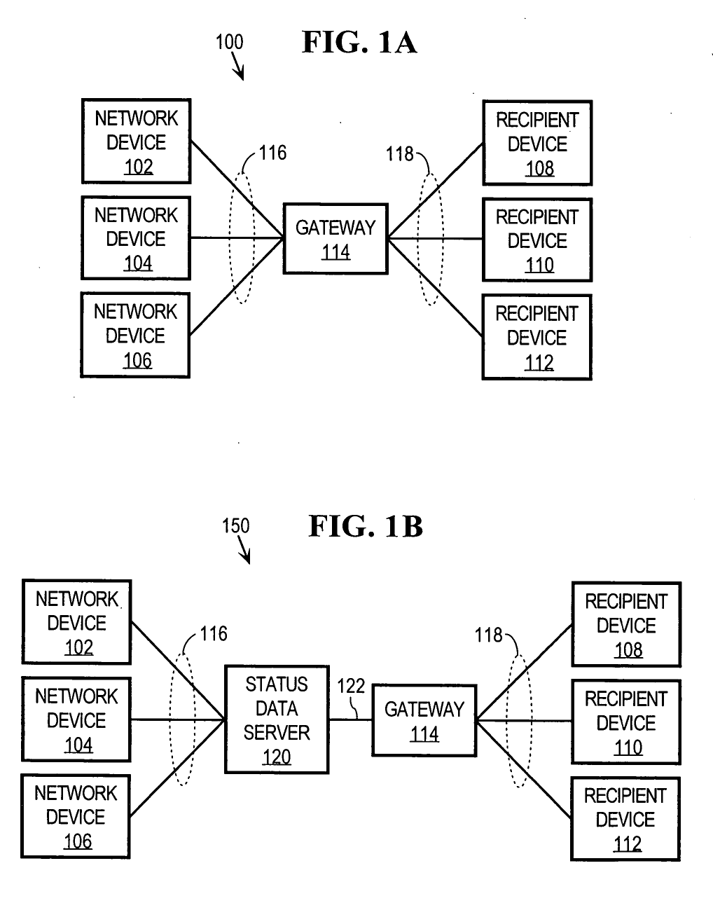

FIG. 1A is a block diagram that depicts a network architecture 100 for collecting and reporting network device status data in accordance with an embodiment of the invention. Architecture 100 includes a group of network devices 102, 104, 106, a group of recipient devices 108, 110, 112, a gateway 114 and links 116, 118. Network devices 102, 104, 106 may be any type of network device to which status data may apply. Examples of network devices 102, 104, 106 include without limitation, copiers, printers, facsimile machines, scanners, multi-function peripherals, computers, workstations, client devices, servers and routers. Recipient devices 108, 110, 112 may be any type of network device for receiving network device status data. Examples of recipient devices 108, 110, 112 include without limitation, computers, workstations and servers.

Links 116, 118 may be implemented using any medium or mechanism for exchanging data between network devices 102, 104, 106, gateway 114 and recipient devices 108, 110, 112. Examples of links 116, 118 include, without limitation, one or more wired or wireless local area networks (LANs), wide area networks (WANs), the Internet, one or more wired or wireless connections, or any combination thereof.

Gateway 114 may be implemented using any mechanism, apparatus or process for performing the functions described herein. Gateway 114 may be implemented using hardware, software, or any combination of hardware and software. Gateway 114 does not necessarily have to perform functionality performed by conventional gateways and any type of intermediary device or mechanism may be used. Although embodiments of the invention are depicted in the figures and described herein in the context of a single gateway 114, multiple gateways may be used to perform the functions described herein. For example, multiple gateways and a load balancing mechanism may be used to provide additional processing capabilities.

Functional Overview

Gateway 114 is configured generally to process status data from network devices 102, 104, 106 and generate and provide report data to recipient devices 108, 110, 112. Gateway 114 may obtain status data directly from network devices 102, 104, 106. Gateway 114 may query network devices 102, 104, 106 for status data or network devices 102, 104, 106 may provide status data to gateway 114 on their own. Gateway 114 may receive status data from network devices 102, 104, 106 asynchronously or according to a specified schedule. According to one embodiment of the invention, gateway 114 collects status data from network devices 102, 104, 106 using the simple network management protocol (SNMP). The invention, however, is not limited to using SNMP for this purpose, and any communications protocol may be used.

Instead of receiving status data directly from network devices 102, 104, 106, gateway 114 may receive status data from an intermediate entity. FIG. 1B is a block diagram that depicts an architecture 150 where gateway 114 receives status data from a status data server 120. Status data server 120 is an apparatus, mechanism or process configured to collect status data from network devices 102, 104, 106. Status data server 120 may use any communications protocol to communicate with network devices 102, 104,106, depending upon the requirements of a particular application. For example, status data server 120 may use SNMT or any other suitable communications protocol to communicate with network devices 102, 104, 106. In this arrangement, gateway 114 generates report data based upon status data received from status data server 120. Network devices 102, 104, 106 may provide status data to status data server 120 asynchronously or according to specified times. Alternatively, Status data server 120 may query status data from network devices 102, 104, 106.

Gateway 114 may provide report data to recipient devices 108, 110, 112 asynchronously or according to a specified schedule. The report data may be generated based upon status data from any number of network devices. For example, gateway 114 may generate report data that reflect status data from one or more of network devices 102, 104, 106. Thus, gateway 114 may aggregate status data from multiple network devices 102, 104, 106. According to one embodiment of the invention, network device status data includes identification data that identifies an intended recipient of the network device status data. The identification data is used to route the network device status data to a particular recipient device. For example, suppose that gateway 214 receives particular network device status data from status data server 220 that contains identification data identifying ERP System B 210 as the intended recipient. As part of its processing, gateway 214 parses the particular status data to retrieve the identification data. For example, gateway 214 may parse extensible markup language (XML) data to locate an XML tag associated with identification data. Gateway 214 examines the identification data to determine at ERP System B 210 is the intended recipient of the report data and routes the report data to ERP System B 210.

According to another embodiment of the invention, gateway 214 is configured to check for a confirmation receipt from a recipient device and if a confirmation receipt is not received, to generate and provide a notification of the condition. For example, suppose that gateway 214 provides report data to ERP System C 212. If, after a specified time, gateway 214 has not received confirmation that the report data was received by ERP System C 212, then gateway 214 generates and sends a notification, for example, to administrative personnel.

Gateway 114 may also be configured with local storage for storing status data received from network devices 102, 104, 106 or status data server 120. The local storage may also be used to store report data generated by gateway 114. This allows gateway 114 to generate report data and then deliver the report data to recipient devices 108, 110, 112 at a later time.

IV. Formatting and Security

The format of status data supported by network devices 102, 104, 106 or status data server 120, depending upon how gateway 114 receives the status data, may be different than the format of report data that is provided to recipient devices 108, 110, 112. According to one embodiment of the invention, gateway 114 is configured to provide a wide variety of data formatting. For example, referring to FIG. 1A, suppose that gateway 114 receives status data from network device 102 in XML format. Suppose further that recipient device 108 supports data in XML format, but uses a different XML schema than network device 102. In this situation, gateway 114 is configured to process the XML status data received from network device 102 that conforms to the XML schema supported by network device 102 and generate XML report data that conforms to the XML schema supported by recipient device 108. As another example, gateway 114 may process the XML status data received from network device 102 and generate report data that conforms to a non-XML format supported by recipient device 108. Gateway 114 may provide report data in different formats to different recipients. For example, gateway 114 may generate first report data that conforms to a first format supported by recipient device 108 and also generate second report data that conforms to a second format supported by recipient device 110, where the first and second formats are different.

Gateway 114 may also be configured to provide security in applications where security is desired. Network devices 102, 104, 106 and status data server 120 may be configured to provide status data to gateway 114 using secure communications or a secure communications protocol. According to one embodiment of the invention, gateway 114 is configured to process report data from network devices 102, 104, 106 and status data server 120 that conforms to a particular security format or protocol. For example, suppose that status data server 120 is configured to encrypt status data sent to gateway 114 over link 122. In this situation, gateway 114 is configured to decrypt the status data received from status data server 120 to recover the original status data and then generate report data based upon the original status data. As another example, gateway 114 may be configured to support a secure Internet protocol, such as HTTPS, or one or more virtual private networks (VPNs).

Gateway 114 may also be configured to provide report data in a secure manner to recipient devices 108, 110, 112. This may include, for example, encrypting report data to be sent to recipient devices 108, 110, 112 and/or using a secure communications protocol, such as HTTPS.

V. Operational Example

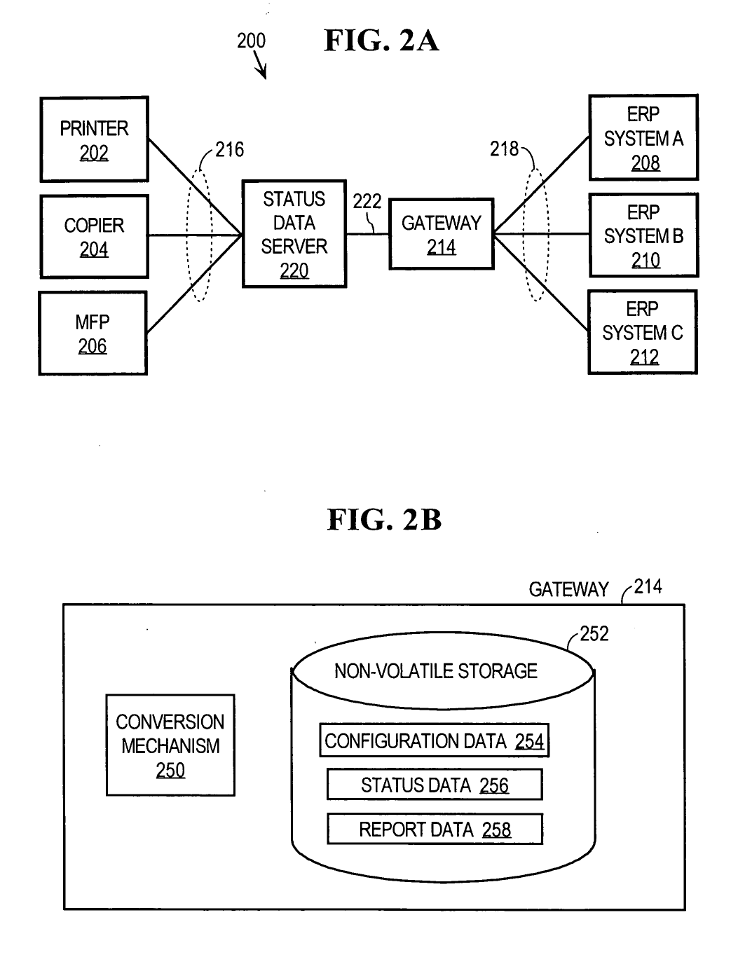

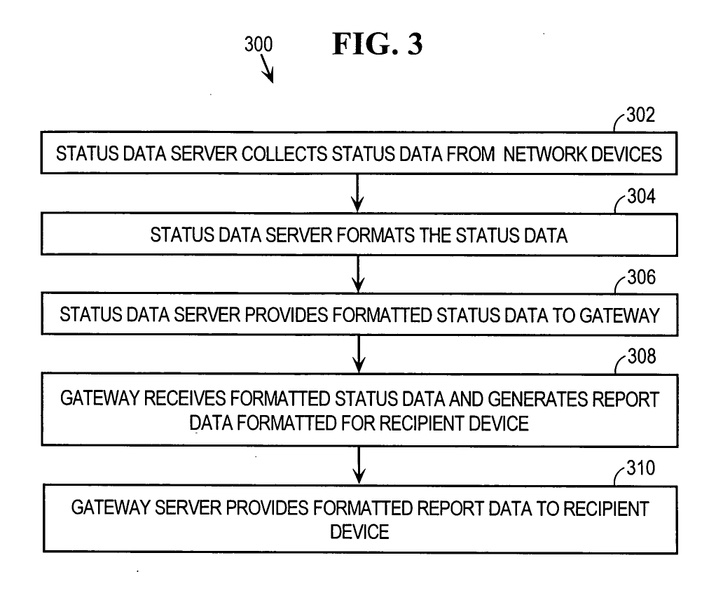

An operational example is now described with reference to FIGS. 2 and 3. FIG. 2A is a block diagram that depicts and arrangement 200 for collecting and reporting network device status data in accordance with an embodiment of the invention. Architecture 200 includes a printer 202, a copier 204, an MFP 206, an ERP System A 208, an ERP System B 210, an ERP System C 212, a gateway 214, a status data server 220 and links 216, 218, 222. ERP System A 208, ERP System B 210 and ERP System C 212 may be implemented at manufacturer or dealer sites.

FIG. 3 is a flow diagram 300 that depicts an approach for collecting and reporting network device status data according to an embodiment of the invention. In step 302, status data server 220 collects status data from printer 202, copier 204 and MFP 206. Status data server 220 may collect status data from printer 202, copier 204 and MFP 206 according to a specified schedule or at random times. Furthermore, status data server 220 may collect status data from printer 202, copier 204 and MFP 206 at the same time or at different times, depending upon the requirements of a particular application. Status data server 220 may collect status data from printer 202, copier 204 and MFP 206 using any type of communications protocol.

In step 304, status data server 220 formats the status data collected from printer 302, copier 304 and MFP 206. For example, status data server 220 may format the data using XML, comma separated values (CSV), or any other suitable format, depending upon the requirements of a particular application. Status data server 220 may also encrypt the formatted status data, for example, using a proprietary algorithm or a public key associated with status data server 220.

In step 306, status data server 220 provides the formatted (and possibly encrypted) status data to gateway 214 over link 222. Status data server 220 may provide the formatted status data to gateway 214 using a variety of techniques, depending upon the requirements of a particular application. For example, status data server 220 may provide the formatted status data to gateway 214 in a message, in an email, or as an email attachment. If the status data is formatted using XML, then the status data may be provided to gateway 214 as an email attachment. Status data server 220 may use any type of communications protocol to communicate the status data to gateway 214 over link 222. SMTP, HTTP, HTTPS and FTP are all example communications protocols that status data server may use for this purpose.

In step 308, gateway 214 receives the status data from status data server 220 and generates report data that conforms to the format required by the recipient device, i.e., ERP System A 208, ERP System B 210 and ERP System C 212. For example, suppose that gateway 214 receives status data from status data server 220 in the form of an email with an encrypted XML attachment that contains status data that specifies a meter reading for MFP 206. Suppose further that this status data is to be reported to ERP System A 208 that supports a comma separated data file format. Gateway 114 decrypts the XML attachment and generates a comma separate data file based upon the XML data contained in the attachment. Gateway 114 may also encrypt the comma separated file if required by ERP System A 208.

In step 310, gateway 214 provides the formatted report data to the recipient device. In the present example, gateway 214 provides the comma separated file to ERP System A 208 over link 218.

FIG. 2B is a block diagram that depicts an example embodiment of gateway 214. As depicted in FIG. 2B, gateway 214 includes a conversion mechanism 250 and a non-volatile storage 252. Gateway 214 may include other modules and elements, depending upon the requirements of a particular application, and FIG. 2B is not meant to depict all of the modules or elements that may be included in gateway 214. Conversion mechanism 250 is configured to process status data received from status data server 220 and generate report data to be provided to ERP System A 208, ERP System B 210 and ERP System C 212. As described herein, this may include parsing and converting the format of status data received from status data server 220 from a format supported by status data server 220 into a format supported by ERP System A 208, ERP System B 210 and ERP System C 212. Gateway 214 may also be configured to decrypt status data received from status data server 220 and encrypt report data to be provided to ERP System A 208, ERP System B 210 and ERP System C 212. Conversion mechanism may be implemented by hardware, software, or any combination of hardware and software. Conversion mechanism 250 may be implemented as one or more multi-threaded processes executing on any number of computing architectures to increase the amount of status data that can be processed simultaneously. Gateway 214 may also be configured to support queuing of messages received from status data server 220. This allows conversion mechanism 250 to process messages asynchronously, based upon the availability of processing resources.

In the present example, gateway 214 includes configuration data 254 stored on non-volatile storage 252 that specifies information needed by conversion mechanism 250 to perform its functions. For example, configuration data 254 may include data that specifies data formats supported by status data server 220 and ERP System A 208, ERP System B 210 and ERP System C 212. Configuration data 254 may also specify how data can be converted from one format to another format. For example, configuration data 254 may specify that a particular transform is to be used to convert data from a first data format supported by status data server 220 to a second data format supported by ERP System A 208. When a change is made to a data format or communications protocol supported by status data server 220 or ERP System A 208, ERP System B 210 and ERP System C 212, configuration data 254 is updated to reflect the change. This reduces the number of devices that need to be updated when formatting or communications protocol changes are made. Non-volatile storage may also include status data 258 received from status data server 220 or other sources, as well as report data generated by conversion mechanism 250. This allows report data 256 to be generated from status data 258 at any time and then delivered to a recipient device, such as ERP System A 208, at a later time.

VI. Implementation Mechanisms

Although embodiments of the invention have been described herein in the context of status data being processed through a gateway, the invention does not require that all network device status data be processed through a gateway. For example, in FIG. 2A, status data server 220 may, in addition to providing status data to gateway 214, provide status data directly to other recipient devices, e.g., an ERP System D (not depicted). Thus, the approach may be used in combination with network devices and intermediary devices, such as status data server 220, that provide status data directly to recipient devices.

The fuctionality performed by the gateways described herein may be implemented using a wide variety of approaches, depending upon the requirements of a particular application. For example, any type of hardware, software or hardware/software combination may be used. Also, any type of computing platform may be used.

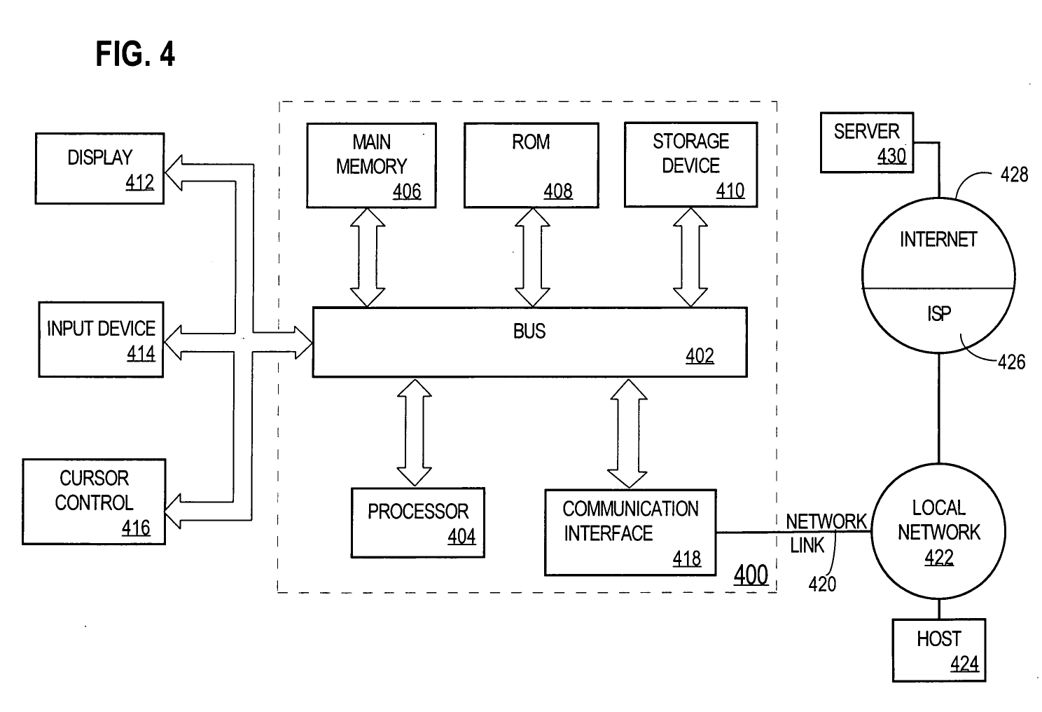

FIG. 4 is a block diagram that illustrates a computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input-device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infrared data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infrared transmitter to convert the data to an infrared signal. An infrared detector can receive the data carried in the infrared signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. An apparatus comprising:
a conversion mechanism configured to
process network device status data that conforms to a first format and is received by the apparatus, and
generate, based upon the status data, report data that conforms to a plurality of formats supported by a plurality of recipient devices.

2. The apparatus recited in claim 1, wherein the network device status data is received by the apparatus directly from a plurality of multi-function peripherals that each perform one or more of printing, copying, faxing and scanning.

3. The apparatus recited in claim 2, wherein the network device status data specifies one or more of consumable levels, a meter reading or need for a service call.

4. The apparatus recited in claim 1, wherein the network device status data is received by the apparatus from a status data server that collects network device status data from a plurality of network devices.

5. The apparatus recited in claim 1, wherein the network device status data received by
the apparatus is encrypted and the apparatus is configured to decrypt the network device status data.

6. The apparatus recited in claim 1, wherein the conversion mechanism is configured to generate the report data in either XML or CSV format.

7. The apparatus recited in claim 1, wherein the network device status data is XML data that conforms to a first XML schema and the report data is XML data that conforms to a second XML schema.

8. The apparatus recited in claim 1, wherein the apparatus is configured to
generate both first report data conforms to a first data format supported by a first recipient device from the plurality of recipient devices and second report data conforms to a second data format supported by a second recipient device from the plurality of recipient devices, and
provide the first report data to the first recipient device and the second report data to the second recipient device.

9. The apparatus recited in claim 1, wherein the apparatus is configured to provide the report data to the plurality of recipient devices using one or more Internet protocols including SMTP, HTTP, HTTPS and FTP.

10. The apparatus recited in claim 1, wherein the apparatus is configured to provide the report data to the plurality of recipient devices based upon a schedule.

11. The apparatus recited in claim 1, wherein the apparatus is configured to provide the report data at a first time to a first recipient device from the plurality of recipient devices and to provide the report data at a second time to a second recipient device from the plurality of recipient devices, wherein the first and second times are different.

12. The apparatus recited in claim 1, wherein the apparatus is configured to provide the report data to the plurality of recipient devices, wherein the report data provided to each of the plurality of recipient devices contains identification data that uniquely identifies the recipient device.

13. The apparatus recited in claim 1, wherein the apparatus is configured to provide a notification if a receipt confirmation indicating receipt of the report data is not received from a particular recipient device from the plurality of recipient devices.

14. The apparatus recited in claim 1, further comprising a storage device for storing the recipient device status data.
